(19) United States
(12) Patent Application Publication
(10) Pub. No.: US 2011/0166921 A1
(43) Pub. Date: Jul. 7, 2011

(54) METHOD FOR ENABLING THE USE OF A MOBILE LOYALTY CARD

(75) Inventors: Michel Degraeve, Rhode-saint-genese (BE); Olivier Markowitch, Bruxelles (BE); Nathanaël Ackerman, Bruxelles (BE)

(73) Assignee: Nolink, Braine L'Alleud (BE)

(21) Appl. No.: 13/054,326

(22) PCT Filed: Jul. 17, 2009
(86) PCT No.: PCT/EP2009/059254

§ 371 Date: Mar. 17, 2011

(30) Foreign Application Priority Data
Jul. 18, 2008 (EP) 08160775.6
Feb. 26, 2009 (EP) 09153735.7

(51) Int. Cl. G06Q 30/00

(52) U.S. Cl. 705/14.23

(57) ABSTRACT

The invention relates to a method for creating a Mobile Loyalty Card (MLC) on a mobile device comprising the steps of:—Subscribing to the MLC service via a mobile device, an internet terminal or any other communication means, the MSISDN number, at least, being provided to the MLC service provider—Downloading on the mobile device software means for enabling the use of MLC service on the mobile device—Creating on the mobile device a MLC by entering at least the Point of Sale (POS) identifier (ID) to the software means while running, the created MLC comprising information related to the type of technology used by the POS reader for transferring data related to the MLC user—Activating on the mobile device, by selecting a MLC, the different technologies used by the reader of the POS linked to the selected MLC.

### FIELD OF THE INVENTION

The invention is related to a method for creating, storing, and managing data related to loyalty cards. More particularly, the invention is related to the storage of loyalty cards on mobile devices and the management of all the services in connection with said cards.

### STATE OF THE ART

The mobile phone becomes a pocket computer able to interact with its environment. Telecommunication operators and equipment providers provide to subscribers a multitude of services, technologies, and networks to facilitate said interactions:
GSM, EDGE, 3Gnetworks . . . to transport vocal and data communications (SMS, MMS, mobile web . . . );
TV broadcasting (DVBH);
Near Field Communication (NFC) which is a short-range wireless connectivity technology designed for bringing two NFC compatible devices within a few centimeters of one another;
IrDA which is a short range (<1 meter), line-of-sight communication standard for exchanging of data over infrared light;
Bluetooth® wireless technology which is designed to replace cables between cell phones, laptops, and other computing and communication devices within a 10-meter range;
Wi-Fi which is also a wireless technology, designed to replace the wired Local Area Network for a dozen computing devices within +/−100 meters range;
Radio Frequency Identification (RFID) which is an automatic identification method, relying on storing and remotely retrieving data using devices called RFID tags. A tag is chip attached to or incorporated into a product. It receives and responds to queries from an RFID reader/writer.

Among all services proposed by the telecommunication sector, the dematerialization of cards represents an added value. The purpose is to use a mobile device (mobile phone, PDA . . . ) to store and operate cards, such as credit cards, access cards, loyalty cards and all associated services.

There are numerous methods related to this matter, which can be classified as follows:
Download of coupon(s) and/or loyalty card(s) via a data network (EP1077437, US2008120186, KR20010074258, US7209733 US2003064713, KR20030065834, KR20040063424, KR20040081506, US2007087732, US2007281692, US2004019571);
Sending of coupon(s) further to a request (EP1077437, US2002138345, KR20030013973, US6934684);
Transaction(s) between an application in the mobile device and a supplier to manage the coupon(s) and/or card(s) via a data network (US6736322, US7146159, CA2539201, US20070021969, W02007/0306639);
Generating barcode(s) on mobile device (CA2539201).

In these documents, two main assumptions are made:
The Points of sale (POS) are all equipped with the right technology corresponding to the method of authentication implemented by the service;
the subscriber operates the adequate choice among the plurality of the transmission means of her/his mobile.

The active involvement of the subscriber is mandatory for configuring her/his mobile device as well as for activating the transmission of data itself.

Let us imagine a customer having a loyalty card and several coupons. At the cash desk of a superstore, she/he has to select her/his loyalty card and the way to transfer it, then she/he selects the coupon(s) and activates their transfer. Even if the user sends collectively all these items, their selection and the process of transfer penalize considerably the efficiency of the cashier.

In prior art documents, the download of cards or coupons, the selection of an offer, the validation of an identity or a pin code requires a connection to a communication network (GSM network, EDGE network) before redeeming the coupons. All this information collection penalize even more the coupon(s) redemption.

Beside, for consumer goods, the cost of the communications must be bourn by somebody, if the subscriber pays, the benefit of the coupon will be lost. If the producer pays, he is charged with additional promotion cost.

None of prior art documents explains how the coupons will be deleted from the mobile device after having been redeemed. In this matter, fraud is a real problem. Industries sources estimate that the losses due to fraud exceed $ 500 billion annually in the United States. In some countries up to 70% of coupons are not properly redeemed.

### SUMMARY OF THE INVENTION

The present invention relates to a method for enabling the use of a Mobile Loyalty Card (MLC) service provided by a MLC service provider, the MLC being provided by a MLC provider and used at one or more Points of Sale (POS), on a mobile device of a MLC user comprising the steps of:
subscribing to the MLC service via any communication means, the MSISDN (Mobile Station Integrated Services Digital Network) number, at least, being provided to the MLC service provider,
downloading on the mobile device of the MLC user software means for enabling the use of MLC service on the mobile device,
obtaining an identifier indicative of the MLC provider,
creating on the mobile device of the MLC user a MLC by entering at least the identifier (ID) of the MLC provider as input data to the software, the created MLC comprising data related to the MLC user and information related to all the types of technologies for transferring data used by the reader of the POS using the MLC,
selecting a MLC on the device, the selection leading to the activation of all the types of technologies for transferring data that are used by the reader of the POS.

Preferably, the method according to the present invention further comprises the step of sending data to the reader using all the technologies activated and used by said reader.

Preferably, the generated MLC is named at the moment of its creation or at any moment afterwards.

Preferably, to each MLC user corresponds a MLC user account, preferably accessible via an internet page, containing all the informations related to the MLCs, preferably all MLCs, created by said MLC user.

Preferably, authentication means, such as a login and/or a password, for accessing to the MLC user account, is assigned at the moment of subscription.

Preferably, the MLC user, when accessing to his/her MLC user account, is selecting one or more coupons, and associates individually each coupon to at least one MLC.

Preferably, coupons available to the MLC user via her/his MLC user account are automatically redeemed when authenticating to a check out at a POS belonging to a MLC provider for which the MLC user has created a MLC.

Preferably, the MLC service provider is a MLC provider.

Preferably, the MLC provider is a POS.

### DESCRIPTION OF THE INVENTION

The present invention relates to a method for creating a Mobile Loyalty Card (MLC) on a mobile device comprising the steps of:
Subscribing to the MLC service via a mobile device, an internet terminal or any other communication means, the MSISDN number, at least, being provided to the service provider
Downloading on the mobile device software means for enabling the use of MLC service on the mobile device
Creating on the mobile device a MLC by entering at least the Point of Sale (POS) identifier (ID) to the software means while running, the created MLC comprising information related to the type of technology used by the POS reader for transferring data related to the MLC user
Activating on the mobile device, by selecting a MLC, the different technologies used by the reader of the POS linked to the selected MLC.

The present invention also relates to a method for enabling the use of a Mobile Loyalty Card (MLC) service, provided by a MLC service provider or by a MLC provider, on a mobile device of a MLC user comprising the steps of:
Subscribing to the MLC service via any communication means, the MSISDN number, at least, being provided to the MLC service provider or to the MLC provider,
Downloading on the mobile device of the MLC user software means for enabling the use of MLC service on the mobile device,
Creating on the mobile device of the MLC user a MLC by entering at least the identifier (ID) of the MLC provider as input data to the software, the created MLC comprising data related to the MLC user and information related to all the type of technology used by MLC provider's readers for transferring data,
Selecting a MLC on the mobile device, the selection leading to the activation of the all technologies for transferring data that can be used by the readers of the MLC provider,
Sending data to the reader using said different technologies that can be used by said readers.

Preferably each USER ID corresponds a user account—accessible via an internet page—containing all the information related to the MLCs belonging to the said user.

Preferably, a password—for accessing to the user account—is assigned at the moment of subscription.

Preferably, the generated MLC can be named at the moment of its creation or at any moment afterwards.

Preferably, the user—when accessing to his/her user account—can select coupons, and associated individually each coupon to at least one MLC.

Preferably, coupons available to the user via her/his user account are automatically discounted when self-identifying to a check out person at a POS for which the user has a MLC.

The present invention aims to solve the drawback of prior art. The method—as disclosed in the present invention—takes into account the authentication means at the

POS, it identifies the subscriber, it simplifies the process of card selection, it automates transfer of information linked to a loyalty card via the wireless network used at the POS and activates the management of coupons, points, rewarding.

The authentication means can comprise a reader that comprises electronic means that are able to transfer data using technologies such as Bluetooth®, Wifi™, NFC, RFID, bar code scaning, laser scanning.

The management of the loyalty cards, coupons, points, rewarding can be performed by a loyalty card management system on the Web that frequently synchronized its data with the readers at the POS check outs.

Preferably the invention relates to a method for storing loyalty cards on a mobile device such as a mobile phone, a personal digital assistant (PDA) or a smart phone and for enabling the authentication of the loyalty card user.

The invention enables to create a Mobile Loyalty Card (MLC) without being necessarily connected to a wireless network such as Wifi network or to a mobile communication network such as GSM, CDMA, EDGE or UMTS networks.

Preferably, the method of the invention comprises at least the steps of subscription, download, creation and activation.

The user can subscribe to the MLC service either by sending a sms, calling a dedicated number, accessing to a dedicated mobile web page or by accessing to a dedicated web page at home, at office or at a Point of Sale (POS).

The MLC service is managed—through a MLC management platform—by the so-called MLC service provider that keeps track of the MLCs belonging to each user and that enables the user to consult his/her MLCs portofolio via an access restricted web page accessible via an internet terminal or via mobile web.

The (MLC) service provider provides to the MLC user a software to be downloaded on his/her mobile device and that enables the (MLC) user to create MLCs on his/her mobile device without the requirement of a connection to a network such as GSM network or Wifi™ network.

When subscribing to a MLC service the (MLC) user, called subscriber at that time, has to provide at least either her/his Mobile phone number (MSISDN), or any identifier which identifies individually each user of mobile device to the (MLC) service provider.

Complementary information such as the first and last names and the address of the subscriber may either be collected or completed by the (MLC) service provider or by Loyalty Card providers according to their requirements.

The term ‘Loyalty Card providers’ is intended to means any company owning stores or franchising stores, any good manufacturer selling its products under a single brand or several brands or any service provider offering its services under a single brand or several brands that offer to their client a Loyalty Card system.

The term ‘Mobile Loyalty Card provider’ refers to means any company owning stores or franchising stores, any good manufacturer selling its products under a single brand or several brands or any service provider offering its services under a single brand or several brands that offer to their client a Mobile Loyalty Card system.

The term ‘Mobile Loyalty Card provider’ can refer to the owner of one or more store(s), for example the owner of one franchising store.

When subscription is completed the (MLC) user receives a (MLC) user identifier ((MLC) user ID) from the (MLC) service provider.

The user ID is based at least on the MSISDN provided by the user at the time of subscription.

The (MLC) user ID is based at least either her/his Mobile phone number (MSISDN), or any identifier which identifying individually each user of mobile device to the MLC service provider.

When subscription is completed the (MLC) service provider gives access to each (MLC) user to a personal web page containing all the data related to the (MLC) user account such as his/her MLCs, his/her points on each MLCs, a list of POS members for which you can create a MLC, advertising from POS member, coupons, etc.

The access to the (MLC) user account is protected by a login and a password provided to the (MLC) user at the moment of the completion of the subscription procedure.

Preferably, the login corresponds to the (MLC) user ID.

Advantageously MLC user accounts of family members can be grouped into one family MLC user account that enable each MLC user belonging the family to share points, coupons, etc.

The software required for creating MLCs can be directly downloaded on the mobile device using either sms wappush, mobile internet or any other downloading method.

The said software can be any software that can run on any mobile device, such as a Java® applet.

Based on said (MLC) USER ID, the said software is able to generate for a given POS a unique MLC for each (MLC) user, by collecting on the mobile device the POS identifier (POS ID).

The POS ID entered by the (MLC) user contains a specific code related to the type of transmission technology used by the reader(s) of the POS—such as a bar code scanning, NFC, Bluetooth—to acquire MLC data for authenticating the MLC user, so that the MLC generated by the said software is able to be red by the said reader.

Preferably said POS ID comprises at least the identifier of the POS, the identifier of the type of technology used by the POS reader or an identifier representative of a combination of several transmission technologies used by the POS reader—for example, bar code and NFC technologies—, and eventually another parameter, such as a validity period, a type of MLC,etc.

Each generated MLC is linked to the POS ID and the (MLC) user ID and can be either a bar code, a picture, a number or any information that enable a POS to identify a customer that subscribed to the loyalty card program of this POS.

The POS ID enables the application to generate a card in the form of an image, which can be named by the user.

The POS ID enables the application to generate a card in the form of an image or in the form of any equivalent representation, which can be named by the (MLC) user.

Said image (MLC) comprises a bar code (D1 or D2 or any other format representative of a code, more particularly an identifier) and the numerical codes of both the POS ID and the (MLC) user ID.

MLCs is stored in a repository file of the mobile device.

Preferably, MLCs belonging to different MLC users can be created on the same mobile device.

Preferably, different user profiles can be created with said software on the mobile device.

Preferably, said software requests to fill in the MLC user's ID for creating a MLC user profile on the mobile device.

The user ID can be request by the software either only at the creation of a user profile on the mobile device or each time the MLC user is creating a MLC associated to his/her profile on the mobile device.

Preferably, a separate repository file is associated to each user profile on the mobile device. The MLCs associated to a user profile on the mobile device are stored in the corresponding repository file.

In the case of the absence of user profiles, at the moment of MLC user requests for creating a MLC, the software can ask to the user to enter his/her user ID and the POS ID or the MLC provider.

At its generation as well as at any moment during its time life a MLC can be renamed by the (MLC) user.

Preferably, for new (MLC) users that had loyalty card before the subscription to the MLC service, a MLC card that keeps track of all the data (points, coupons, . . . ) linked to the ‘old’ card can be generated at any moment through the MLC user account.

Preferably, the authentication occurs at the check out of the POS.

When the (MLC) user selects a MLC, the MLC software retrieves from the MLC information related to the transmission technologies used by the reader at the POS and controls the mobile device in such a way that it enables the transmission of MLC information to the POS reader

For example, after the selection of the MLC, the MLC software identifies that Bluetooth and NFC technologies are used by the reader of the POS corresponding to the selected MLC. Then, the MLC software activates Bluetooth and NFC function in the mobile device. As consequence, the mobile device is then ready to transfer information about the MLC user to the POS reader through both Bluetooth and NFS data transmission.

Preferably once the MLC is selected, the POS check out has 3 means to authenticate the MLC owner: (I) scanning the barcode, (II) acquiring the bar code via wireless or contactless transmission and, in the absence of transmission mean, (III) by manually entering the bar code.

Preferably, the said (POS) reader is continuously in communication with the POS MLC management platform.

The POS MLC management platform enables the POS manager to configure their MLCs, in particular by defining the types of reader—i.e. the type of technology used by the reader to acquire the data related to the MLC such as Bluetooth, Wifi, NFC—used at the POS, to update information relative to MLCs, to select and configure the services associated with each type of MLC such the system to calculate the points, the distribution mode of coupons, etc.

The authentication of the (MLC) user at the POS is realised either by scanning the mobile device when displaying the MLC, by transferring data for authentication via contactless communication, via Bluetooth® communication, via any wireless communication between the (MLC) user and the POS or by any communication means between the (MLC) user and the POS MLC management platform.

Further to a change of the type of technology used by the reader to acquire the data related to the MLC—such as Bluetooth, Wifi, NFC—, the subscriber just has to introduce the new POS identifier into the dedicated interface of her/his mobile communication device to create a new MLC, taking into account the technological evolution of the POS.

The former card will not be in service anymore and can be deleted by the subscriber.

Preferably, the reader will only have access to the repository file containing the MLCs.

The said reader contacts the POS MLC management platform either directly after the purchase subsequent to (MLC) user authentication, later in the day or during the following night to update (MLC) user's data linked to the MLC.

Preferably, said reader contacts the POS MLC management platform at the moment of authentication of MLC user.

Preferably, the deletion of the redeemed coupons occurs at the moment of authentication of MLC user.

The (MLC) user is allowed to associate coupons to its MLCs through its (MLC) user account or through its mobile device.

When connected to his/her (MLC) user account the (MLC) user has access to coupons that give access to discount either to a unique POS, to several POS or to each POS selling the targeted goods or the targeted services.

For example, one or several interactive terminals are present at the POS and enable to the (MLC) users to connect to their (MLC) user account. Therefore, they can select coupons and/or associate them to one or several MLCs.

The user can request through its user account to automatically associate coupons for a defined good or brand to one or several MLCs.

The (MLC) user can request through its (MLC) user account to automatically associate coupons for a defined service, good or brand to one or several MLCs.

The MLC user can request through its (MLC) user account to automatically associate all coupons available at a POS to the MLC of the said POS. Therefore, after each authentication the (MLC) user will benefit from all the coupons linked to purchased goods.

The POS manager can request—thanks to the POS MLC management platform—to associate all coupons available at the POS to all (MLC) users or to a subset of (MLC) users. Therefore, after each authentication these (MLC) users will benefit from all the coupons linked to purchased goods.

The same method for creating and managing MLC applies mutatis mutandis to the case of goods manufacturers or a service providers that offer there production or service in a set of POS belonging to one brand or in different set of POS belonging to different brand, the MLC being linked in this case to the goods manufacturers or a service providers and not the set of POS.

1. A method for enabling the use of a Mobile Loyalty Card (MLC) service provided by a MLC service provider, the MLC being provided by a MLC provider and used at one or more Points of Sale (POS), on a mobile device of a MLC user comprising the steps of:
subscribing to the MLC service via any communication means, the MSISDN (Mobile Station Integrated Services Digital Network) number, at least, being provided to the MLC service provider,
downloading on the mobile device of the MLC user software means for enabling the use of the MLC service on the mobile device,
obtaining an identifier indicative of the MLC provider, the identifier comprising a code identifying all types of technology for transferring data used by MLC provider's readers at said one or more POS,
creating on the mobile device of the MLC user a MLC by entering at least the identifier (ID) of the MLC provider as input data to the software, the created MLC comprising data related to the MLC user and information related to all said types of technology for transferring data used by the MLC provider's readers,
selecting the MLC on the mobile device, the selection leading to the activation of all said types of technology for transferring data that are used by the MLC provider's readers.

2. The method of claim 1, further comprising the step of sending data to one or more of said readers using all of the types of technology activated and used by said one or more readers.

3. The method of claim 1, wherein the generated MLC is named at the moment of its creation or at any moment afterwards.

4. The method of claim 1, wherein to each MLC user corresponds a MLC user account, preferably accessible via an internet page, containing all the informations related to the MLCs, preferably all MLCs, created by said MLC user.

5. The method of claim 4, wherein authentication means, such as a login and/or a password, for accessing to the MLC user account, is assigned at the moment of subscription.

6. The method of claim 4, wherein the MLC user, when accessing to his/her MLC user account, is selecting one or more coupons, and associates individually each coupon to at least one MLC.

7. The method of claim 4, wherein coupons available to the MLC user via her/his MLC user account are automatically redeemed when authenticating to a check out at a POS belonging to a MLC provider for which the MLC user has created a MLC.

8. The method of claim 1, wherein the MLC service provider is a MLC provider.

9. The method of claim 1, wherein the MLC provider is a POS.

10. A method for enabling the use of a Mobile Loyalty Card (MLC) service provided by a MLC service provider on a mobile device of a MLC user, wherein a MLC is provided by a MLC provider for use at one or more Points of Sale (POS), comprising the steps of:
subscribing to the MLC service by providing the MLC service provider with an identifier which identifies the MLC user,
downloading on the mobile device of the MLC user software means comprising means configured to create the MLC on the mobile device,
obtaining an identifier indicative of the MLC provider, the identifier comprising data identifying one or more types of transmission technology used at the POS by one or more MLC readers,
creating the MLC on the mobile device by entering at least the identifier of the MLC provider as input data to the software means, the created MLC comprising data enabling to identify the MLC user and data related to at least one of the one or more types of transmission technology used at the POS by one or more MLC readers.

11. The method of claim 10, wherein the MLC is configured to transmit MLC data to a reader of the POS using any one of said one or more types of transmission technology.

12. The method of claim 10, comprising selecting the MLC on the mobile device by the MLC user, the selection leading to the activation on the mobile device of at least one of said one or more types of transmission technology for transferring data to a reader of the POS.

13. The method of claim 10, wherein upon selection of the MLC on the mobile device by the MLC user, the software means is configured to retrieve the data related to the one or more types of transmission technology used by the reader of the POS from the MLC, and to control the mobile device by the software means to enable the transmission of the MLC data.

14. The method of claim 10, wherein the software means enables to create different MLCs for a plurality of MLC providers, each MLC being created based on an identifier of the MLC providers.

15. The method of claim 10, wherein the software comprises means configured to identify data identifying one or more types of transmission technology used at the POS by one or more MLC readers within the identifier of the MLC provider without requiring remote access to the MLC service provider.

16. The method of claim 10, wherein the MLC is created locally on the mobile device by the software means, without connection to a data transmission network.

17. The method of claim 10, wherein the identifier of the MLC user is the MSISDN (Mobile Station Integrated Services Digital Network) number.

18. The method of claim 10, wherein the identifier of the MLC provider comprises a code identifying one or more types of transmission technology used at the POS by one or more MLC readers for acquiring data of the MLC.

19. The method of claim 10, wherein said one or more types of transmission technology are selected from bar code scanning and wireless transmission between the mobile device and the POS reader.

20. The method of claim 10, wherein the MLC is configured to enable the transmission of MLC data to the reader of the POS by multiple types of transmission technology.
